(19) United States
(12) Patent Application Publication
(10) Pub. No.: US 2007/0192732 A1
(43) Pub. Date: Aug. 16, 2007

(54) CONTROLLING DISPLAY OF WINDOWS

(75) Inventors: Keisuke Nitta, Yamato-shi (JP); Hideaki Shinomi, Yokohama-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/673,625

(22) Filed: Feb. 12, 2007

(30) Foreign Application Priority Data
Feb. 13, 2006 (JP) 2006-35814

(51) Int. Cl. G06F 3/048

(52) U.S. Cl. 715/788

(57) ABSTRACT

A system controls the display of windows in accordance with designation of a user. The system includes a reference detecting unit for detecting a reference relation between a designated window and respective one of other windows, the reference relations being a relation where a content displayed on one window includes a reference to a content displayed on the other window. The system may also include a priority computing unit for computing and assigning to the window for which the reference relation with the designated window has been detected a higher display priority than the window for which the reference relation with the designated window has not been detected and a display control unit for displaying the windows on a screen in accordance with the display priorities.

### BACKGROUND OF THE INVENTION

The present invention relates to controlling the display of windows. More particularly, the present invention relates to automatically determining display priorities of windows.

In recent years, a window system capable of displaying a plurality of windows has been adopted in an information processing apparatus such as a personal computer. With this window system, a user can make related contents displayed on a plurality of windows, and compare them with each other, or edit the content displayed on one window by referring to the content displayed on another window. When a large number of windows are displayed in a stacked manner on a screen, however, it is difficult for the user to find a desired window.

A variety of functions are used to facilitate finding of a window. For example, according to the Microsoft® Windows® operating system (Microsoft and Windows are trademark of Microsoft Inc. in the United States, other countries, or both) registered trademark), a task bar is displayed independently of the windows, and not only the windows now on display but also the windows temporarily not on display are listed in the task bar. There is another technique to change the display positions of the windows displayed on a screen so as to organize them. For example, in the Windows operation system, a function (tile display function) for positioning a plurality of windows on a screen not to overlap with each other is prepared. A function (cascade display function) for stacking a plurality of windows with their display positions shifted from each other is prepared as well.

In addition, Windows operating system is also provided with a function to display the windows by symbolizing them and displaying them side by side in order from the one most recently manipulated (it is known that this function is called by depressing the ALT key and the TAB key). According to this function, the user can readily find the window most recently manipulated. There is also proposed another technique with which, when the screen becomes crowded, the window of which visible area is the smallest is erased. According to this technique, it is possible to automatically find an unnecessary window and organize the windows without the intervention of the user.

### BRIEF SUMMARY OF THE INVENTION

According to one aspect of the present invention, a system for controlling display of windows in accordance with designation of a user comprises a reference detecting unit for detecting a reference relation between a designated window and respective one of other windows, the reference relation being a relation where a content displayed on one window includes a reference to a content displayed on the other window, a priority computing unit for computing and assigning to the window for which the reference relation with the designated window has been detected a higher display priority than the window for which the reference relation with the designated window has not been detected, and a display control unit for displaying the windows on a screen in accordance with the display priorities.

According to another aspect of the present invention, a method for controlling display of windows in accordance with designation of a user comprises detecting a reference relation between a designated window and respective one of other windows, the reference relation being a relation where a content displayed on one window includes a reference to a content displayed on the other window; computing and assigning to the window for which the reference relation with the designed window has been detected a higher display priority than the window for which the reference relation with the designated window has not been detected; and displaying the windows on a screen in accordance with the display priorities.

According to yet another aspect of the present invention, a computer program product causing an information processing apparatus to function as a system that controls display of windows in accordance with designation of a user comprises a computer usable medium having computer usable program code embodied therewith. The computer usable program code comprises computer usable program code configured to detect a reference relation between a designated window and respective one of other windows, the reference relation being a relation where a content displayed on one window includes a reference to a content displayed on the other window; computer usable program code configured to compute and assign to the window for which the reference relation with the designated window has been detected a higher display priority than the window for which the reference relation wit the designated window has not been detected; and computer usable program code configured to display the windows on a screen in accordance with the display priorities.

### BRIEF DESCRIPTION OF THE SEVERAL VIEWS OF THE DRAWINGS

FIG. 1 shows an overall configuration of information processing system 10;

FIG. 2 shows a first display example of screen 25;

FIG. 3 shows a second display example of screen 25;

FIG. 4 shows a functional configuration of web server 40;

FIG. 5 is a flowchart of processing for controlling display of windows based on reference relations;

FIG. 6 shows details of processing in S510;

FIG. 7 shows details of processing in S600 and S630;

FIG. 8 shows details of processing in S520;

FIG. 9 shows a display example of screen 25 after the arrangement of the windows is changed; and

FIG. 10 shows an example of hardware configuration of information processing apparatus 800 that functions as web server 40.

### DETAILED DESCRIPTION OF THE INVENTION

The various aspects of the present invention may be embodied as a computer method, a system of computer program product. Also, various aspects of the present invention may take the form of an entirely hardware embodiment, an entirely software embodiment (including firmware, resident software, micro-code, etc.). Moreover, embodiments or aspects thereof, such as block(s) illustrated in the diagrams of the figures, may be generally referred to, either individually or collectively as a “circuit,” “module” or “system.” Furthermore, the various aspects of the present invention may take the form of a computer program product on a computer-usable storage medium having computer-usable program code embodied in the medium.

The software aspects of the present invention may be stored, implemented and/or distributed on any suitable computer usable or computer readable medium(s), including but not limited to, any medium that can contain, store, communicate, propagate or transport the program for use by or in connection with a instruction execution system of a corresponding processing device. The computer program product aspects of the present invention may have computer usable or computer readable program code portions thereof, which are stored together or distributed, either spatially or temporally across one or more devices. A computer-usable or computer-readable medium may comprise, for example, an electronic, magnetic, optical, electromagnetic, infrared, or semiconductor system, apparatus, device, or propagation medium.

More specific examples of the computer usable or computer readable medium comprise for example, an electrical connection having one or more wires, a swappable intermediate storage medium such as floppy drive, tape drive, external hard drive, a portable computer diskette, a hard disk, a random access memory (RAM), a read-only memory (ROM), an erasable programmable read-only memory (EPROM or Flash memory), a portable compact disc read-only memory (CD-ROM) or digital video disk (DVD), an optical fiber or storage device, or a transmission media such as those supporting the Internet or an intranet. The computer-usable or computer-readable medium may also comprise paper or another suitable medium upon which the program is printed, as the program can be electronically captured, for example, via optical scanning of the paper or other medium, then compiled, interpreted, or otherwise processed in a suitable manner, if necessary, and then stored in a computer memory. The computer-usable medium may include a propagated data signal with the computer-usable program code embodied therewith, either in baseband or as part of a carrier wave or a carrier signal. The computer usable program code may also be transmitted using any appropriate medium, including but not limited to the Internet, wireline, optical fiber cable, RF, etc.

Computer program code for carrying out operations of the present invention may be written in any suitable language, including for example, an object oriented programming language such as Java, Smalltalk, C++ or the like. The computer program code for carrying out operations of the present invention may also be written in convention procedural programming languages, such as the “C” programming language, or in higher or lower level programming languages. The program code may execute entirely on a single processing device, partly on one or more different processing devices, as a stand-alone software package or as part of a larger system, partly on a local processing device and partly on a remote processing device or entirely on the remote processing device or server. In the latter scenario, the remote processing device may be connected to the local processing device through a network such as a local area network (LAN) or a wide area network (WAN), or the connection may be made to an external processing device, for example, through the Internet using an Internet Service Provider.

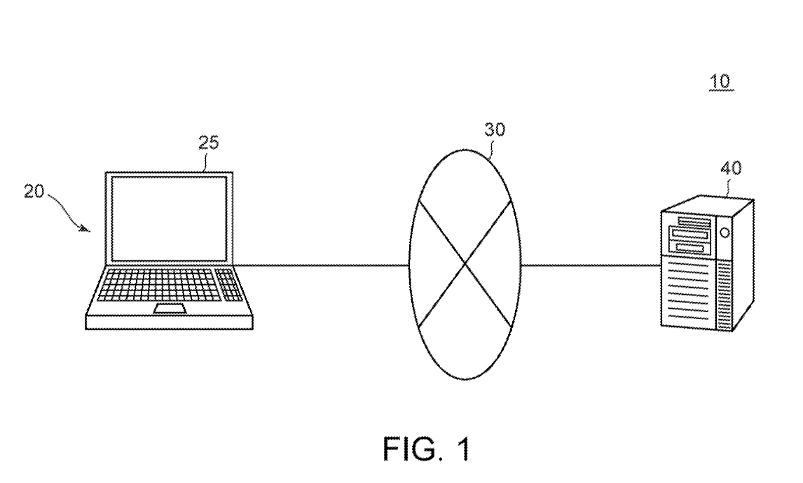

FIG. 1 shows an overall configuration of an information processing system 10. Information processing system 10 includes a user terminal 20 and a web server 40. User terminal 20 receives an input from a user, and displays a processing result based on the input on a screen 25. User terminal 20 is connected to web server 40 via a network 30, and communicates with web server 40 in accordance with an input from the user. Web server 40 transmits data to user terminal 20 in accordance with a request received from user terminal 20, and causes it to be displayed on screen 25. User terminal 20 may display a plurality of windows on screen 25 based on an instruction of web server 40.

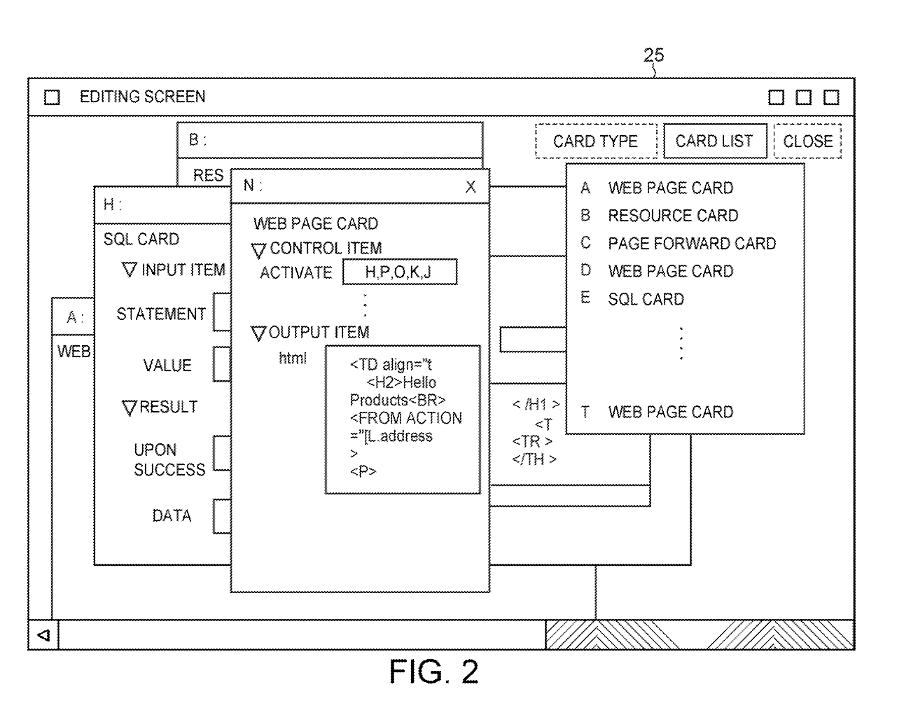

FIG. 2 shows a first display example of screen 25. A plurality of windows on screen 25 can display contents different from each other. In the display example of FIG. 2, an operation screen of a program for creating a web application is shown as an example of the contents. This program displays a plurality of software components constituting the web application on respective windows called “cards”. In each of the windows, an alphabet is displayed as an identifier of the card. In the example of FIG. 2, user terminal 20 displays 20 windows respectively showing cards A to T. The titles of these cards are displayed as a list in response to manipulation of a button of “card list” or the like. Hereinafter, the window showing a certain card X will be referred to as “windows X” and the like.

A window N displays the content of one web page constituting a web application. Specifically, window N is provided with a control item and an output item. The control item includes an identifier of another card on the column of “activate”. The identifier indicates a card that displays an operation content of a program activated in response to the display of this web page. That is, when the web page displayed on window N is displayed, the programs displayed on the respective cards H, P, O, K, and J are activated.

The output item of window N includes a source file defining the display of this web page. The source file may be described in HTML (Hyper Text Markup Language), for example. The other windows may each show the content of a web page, as in the case of window N, or the operation content of a program of a web service or the like. For example, window H displays a card for describing a command of SQL (Structured Query Language). The command is issued to the database when windows H is called from a card of another window.

By editing the cards explained above, the user can create the software components constituting a web application, even if he/she does not have any special knowledge on program language such as Java (registered trademark).

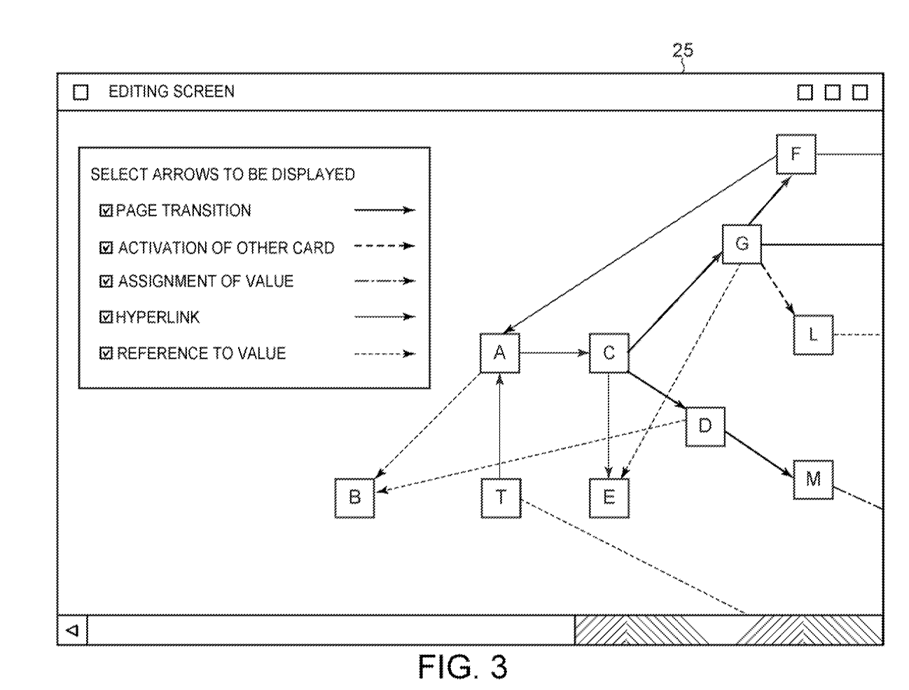

FIG. 3 shows a second display example of screen 25. User terminal 20 may display the respective windows in the first display example as icons. The icons provided with alphabets in FIG. 3 correspond to the windows having those alphabets as identifiers. That is, screen 25 displays icons corresponding respectively to windows A, B, C, D, E, F, G, L, M, and T.

In the example shown in FIG. 3, user terminal 20 may display reference relations among the windows based on an instruction of web server 40. The reference relations are represented by different arrows for different types of relations. For example, there are five types of reference relations of page transition, activation of other card, assignment of value, hyperlink, and reference to value. The reference relation of page transition means the relation where user's manipulation of a manipulating object displayed on a first web page causes a second web page to be displayed. For example, window A and window C have this reference relation. That is, in response to the event that the user manipulates an object for manipulating a web page that is displayed on window A, a web page displayed on window C is displayed. More specifically, the web page displayed on window A may include a HTML tag for causing transition of display to the web page displayed on window C. The tag may be a FORM tag, for example, having its ACTION attribute designating transition to the web page displayed on window C. In this case, the attribute values of the other attributes of the FORM tag may be provided to the web page that is the target of transition. Further, the manipulating object states here refers, e.g., to a button that can be clicked by a point device.

The reference relation of activation of other card means the relation where execution of a first program causes a second program to be activated. For example, window G and window L have this reference relation. That is, when the first program displayed on window G is executed, the second program displayed on window L is activated secondarily. Specifically, it is the relation where, assuming that the first program is a program to display a web page, for example, the second program is activated secondarily in response to display of the relevant web page. Further, the reference relation of assignment of value means the relation where an operation of a certain program causes a value defined in another window to be changed. For example, window M and a window outside the displayed area have this reference relation. That is, in accordance with the operation of the program displayed on window W, the value defined in the window not included in the area displayed in FIG. 3 is changed.

The reference relation of hyperlink means the relation where one of the first and second web pages is referred to by a hyperlink of the other. For example, window A and window T have this reference relation. That is, the web page of window A is referred to by the hyperlink included in the web page of window T. Furthermore, the reference relation of reference to value means the relation where a certain program causes a value of a variable defined in another window to be referred to. For example, window B and window D have this reference relation. That is, the program displayed on window D refers to the value of the variable in window B during the operation of the program.

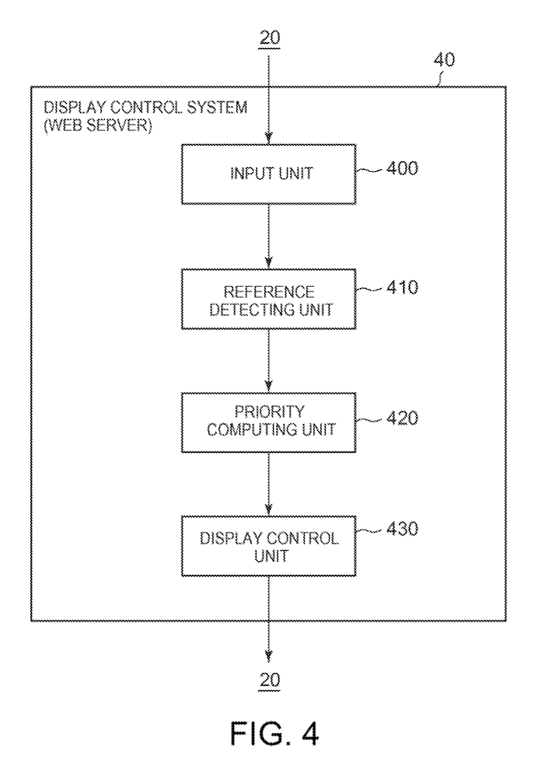

FIG. 4 shows a functional configuration of web server 40. Web server 40 not only functions as a server transmitting information of a screen in response to a request, but also functions as a system for controlling display of windows. Specifically, web server 40 has an input unit 400, a reference detecting unit 410, a priority computing unit 420, and a display control unit 430. Input unit 400 receives from a user an input to a window displayed on screen 25. Input unit 400 determines whether any window has been designated by the user. For example, input unit 400 may determine that a window has been designated on the condition that a manipulation to activate the windows has been received. Alternatively, input unit 400 may determine that a window has been designed on the condition that a specified key manipulation has been received on the activated state.

Reference detecting unit 410 detects a reference relation between a designated window and respective one of the other windows, which is the relation where a content displayed on one window includes a reference to a content displayed on the other window. Specifically, firstly, in response to the event that an input designating a window has been received by input unit 400, reference detecting unit 410 scans the content displayed on the designated window and the contents displayed on the respective other windows. Reference detecting unit 410 then detects a reference from respective one of the windows to any of the other windows. Based on the detected reference, reference detecting unit 410 detects the references relation between the designated window and respective one of the other windows. In addition thereto, reference detecting unit 410 may also detect, based on the detected reference, a reference relation between the window for which the reference relation with the designated window has been detected and yet another window.

Priority computing unit 420 computes and assigns to the window for which the reference relation with the designated window has been detected a display priority that is higher than that of the window for which the reference relation with the designated window has not been detected. Display control unit 430 displays the respective windows on a screen in accordance with the computed display priority. For example, display control unit 430 may display the windows in a stacked manner on screen 25 such that the window of a higher display priority hides at least a part of the window of a lower display priority.

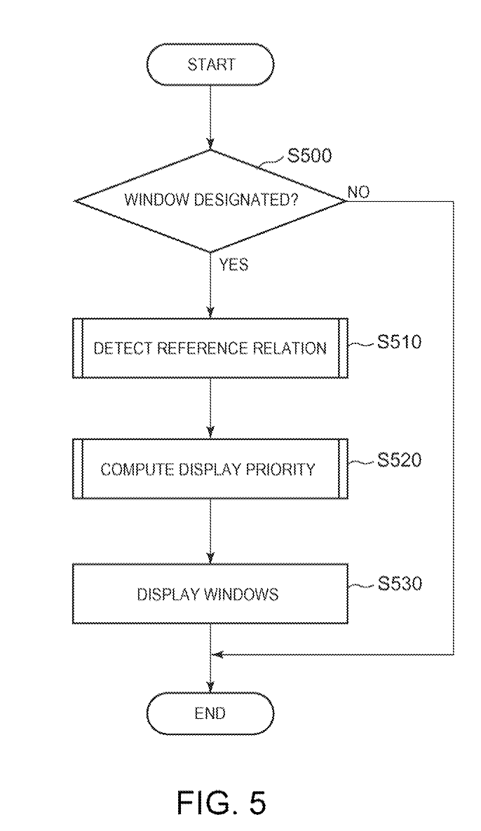

FIG. 5 is a flowchart of processing for controlling display of windows based on the reference relations. Input unit 400 determines whether any window has been designated by a user (S500). In response to the designated of a window (S500): YES), reference detecting unit 410 detects a reference relation between the designated window and respective one of the other windows (S510). Here, reference detecting unit 410 may also detect a transitive reference relation starting at the designated window. That is, reference detecting unit 410 may detect the reference relation between the designated window and respective one of the other windows, and further detect the reference relation between the window for which the reference relation has been detected and yet another window. In addition therein, reference detecting unit 410 may further select one window that cannot be reached form the designated window via the reference relation, and detect a transitive reference relation starting at the one window.

Priority computing unit 410 computes the display priority of the respective windows based on the detected reference relations (S520). Specifically, priority computing unit 420 may compute and assign to the window reachable form the designated window via the reference relation(s) a display priority that is higher than that of the window not reachable from the designated window via the reference relation. Further, priority computing unit 420 may compute and assign to one window not reachable form the designated window and to the window for which the reference relation with the one window has been detected, a display priority that is next higher to that of the window reachable from the designated window. Display control unit 430 displays the respective windows on the screen in accordance with the computed display priority (S530).

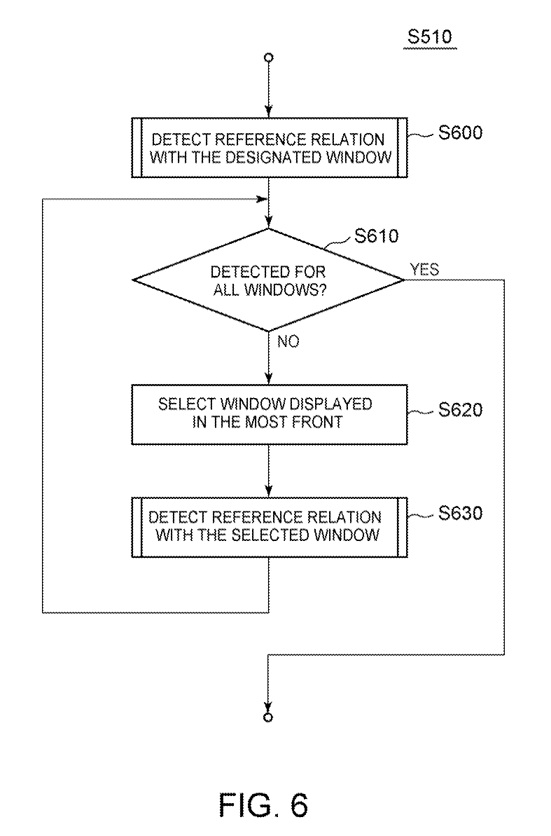

FIG. 6 shows details of the processing in S510. Reference detecting unit 410 detects a transitive reference relation starting at the designated window (S600). Next, reference detecting unit 410 determines whether the reference relation with another window has been detected for all of the windows on screen 25 (S610). If so (S610: YES), reference detecting unit 410 terminates the processing in S510. If not (S610: NO), reference detecting unit 410 selects one window that cannot be reached form the designated window via any reference relation (S620). For example, reference detecting unit 410 may select from among the windows not reachable from the designated window via any reference relation, the one originally having the higher display priority, e.g., the window displayed in the most front. Reference detecting unit 410 then detects any reference relation between the selected window and respective one of the other windows (S630), and returns the processing to S610.

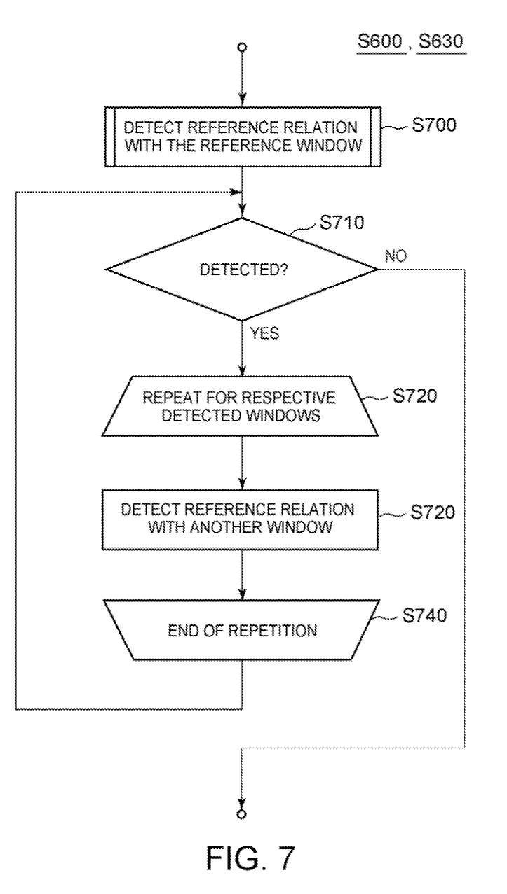

FIG. 7 shows details of the processing in S600 and S630. The processing of detecting a transitive reference relation starting at a certain reference window will now be described with reference to FIG. 7. Although S600 and S630 will collectively be explained in conjunction with FIG. 7, the reference window in S600 is the window designated in S500, while the reference window in S630 is the window selected in S620. Reference detecting unit 410 firstly detects a reference relation between the reference window and respective one of the other windows (S700).

If not reference relation is newly detected (S710: NO), reference detecting unit 410 terminates the processing of detecting the reference relations. On the condition that a reference relation has newly been detected (S710: YES), reference detecting unit 410 performs the following processing for the respective windows for which the reference relation has newly been detected (S720). Namely, reference detecting unit 410 detects a reference relation between the window for which the reference relation has newly been detected and other windows for which no reference relation has been detected yet (S730). Reference detecting unit 410 repeats the above processing for each window for which the reference relations has newly been detected (S740).

As described above, according to the processing shown in FIGS. 6 and 7, it is possible to detect a group of windows that can be reached transitively form a designated window via reference relations. Further, for the other windows as well, it is possible to detect a group of windows reachable transitively form a reference window via reference relations. As such, the windows displayed on screen 25 can be grouped into a plurality of groups each including a plurality of windows related to each other.

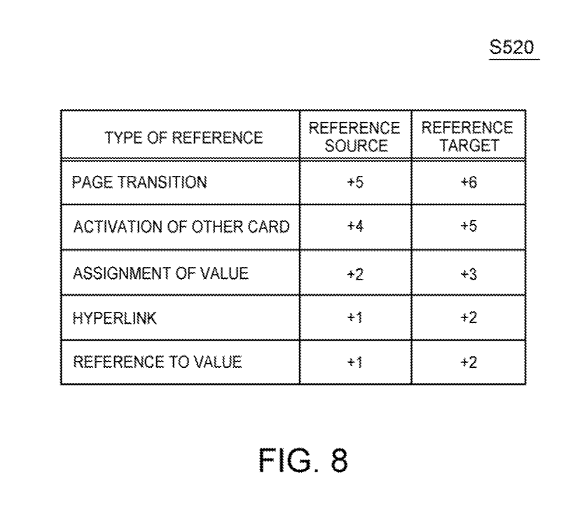

FIG. 8 shows details of the processing in S520. Priority computing unit 420 computes the display priority for the respective windows reachable from the designated window. The display priority of each window is determined in accordance with the type of reference for which the relevant window corresponds to the reference source or reference target, as shown in FIG. 8. Further, the display priority computed for each window is higher on the condition that the relevant window corresponds to the reference target of the reference than in the case that is the reference source of the reference. This will be described more specifically in the following.

There is a case where a first window and a second window among the windows reachable form the designated window display a first web page and a second web page, respectively. In this case, priority computing unit 420 determines whether the reference relation between these windows corresponds to the relation (reference relation of page transition) with which the second web page is displayed in response to the user's manipulation of a manipulating object displayed on the first web page. On the condition that it corresponds to the relevant relation, priority computing unit 420 computes and assigns to the windows higher display priorities than in the case of the reference relation of the other type. For example, priority computing unit 420 computes and assigns the priority of +5 and +6 to the reference source and the reference target, respectively, of the reference relation of page transition.

There also is a case where a first window and a second window among the windows reachable from the designated window display an operation content of a first program and an operation content of a second program, respectively. In this case, priority computing unit 420 determines whether the reference relation between these windows corresponds to the relation (reference relation of activation of other card) with which the second program is activated in response to an operation of the first program. On the condition that it corresponds to the relevant relation, priority computing unit 420 computes and assigns to the windows higher display priorities than in the case of the reference relation of the other type. For example, priority computing unit 420 may compute and assign the prioritys of +4 and +5 to the reference source and the reference target, respectively, of the reference relation of activation of other card.

Further, there also is a case where, of the windows reachable from the designated window via reference relations, a first window display a content including definition of a variable, and a second window display an operation content of a program. In this case, priority computing unit 420 determines whether the reference relation between them corresponds to the relation (reference relation of assignment of value) with which the value of the variable defined in the first window is changed in accordance with the operation of the relevant program. On the condition that it corresponds to the relevant relation, priority computing unit 420 computes and assigns to the first and second windows the display priorities lower than in the case where the program is activated by the user's manipulation of the manipulating object and higher than in the other cases. For example, priority computing unit 420 may compute and assign the prioritys of +2 and +3 to the reference source and the reference target, respectively, of the reference relation of assignment of value.

Furthermore, there also is a case where a first window and a second window among the windows reachable from the designated window via reference relations display a content of a first web page and a content of a second web page, respectively. In this case, priority computing unit 420 determines whether their reference relation corresponds to the relation (reference relation of hyperlink) with which one of the first and second web pages is referred to by the hyperlink of the other. On the condition that it corresponds to the relevant relation, priority computing unit 420 computes and assigns to the first and second windows display priorities lower than in the case where the value of the variable defined is changed by the operation of the program and higher than in the other cases. For example, priority computing unit 420 may compute and assign the prioritys of +1 and +2 to the reference source and the reference target, respectively, of the reference relation of hyperlink.

Still further, there also is a case where, of the windows reachable from the designated window via the reference relations, a first window displays a content including definition of a variable and a second window displays an operation content of a program. In this case, priority computing 420 determines whether their reference relation corresponds to the relation (reference relation of reference to value) with which the value of the variable is referred to by the program. On the condition that it corresponds to the relevant relation, priority computing unit 420 computes and assigns to the windows display priorities lower than in the case where the value of the variable defined is changed by the operation of the program and higher than in the other cases. For example, priority computing unit 420 may compute and assign the priorities of +1 and +2 to the reference source and the reference target, respectively, of the reference relation of reference to value.

The priorities computed as described above are summed up for each window. Priority computing unit 420 regards the priority summed up for each of the windows as the display priority to be assigned thereto.

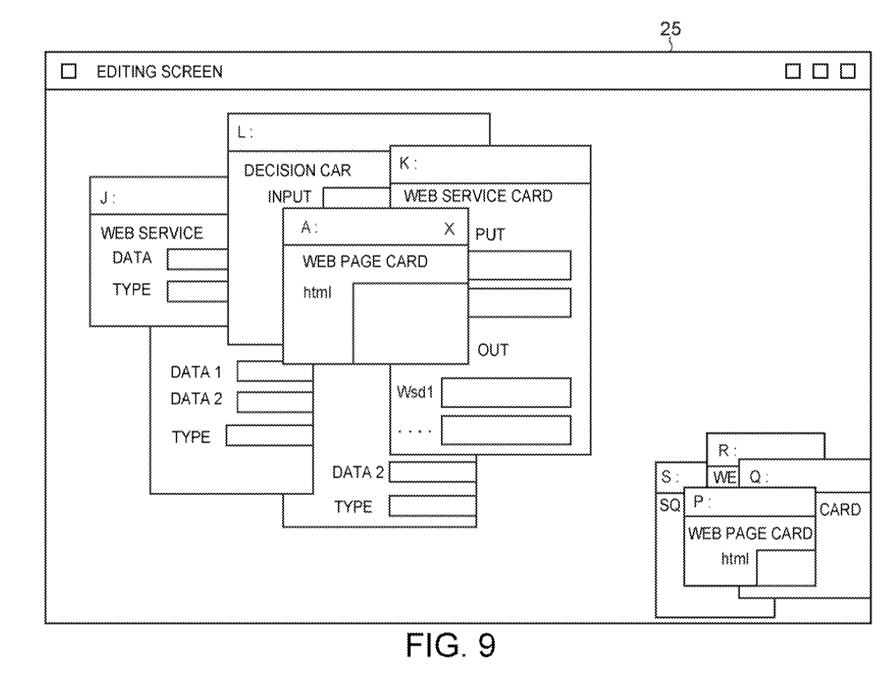

FIG. 9 shows a display example of screen 25 after the arrangement of the windows has been changed. As in the example shown in FIG. 2, the windows each show a web page, a program or the like. Further, each window shows an identifier of the variable defined in the relevant web page or program on the left side of the row, and displays the value of the relevant variable on the right side of the row. For example, a character string of “html” or the like is the identifier, and the html source code is the value of the variable. The value of the variable is displayed on an input column or the like, and the user can freely rewrite the value. Further, each window has an identifier of the relevant window displayed near an upper side of the window. For example, the display of “web page card” or the like is the identifier of the window.

Display control unit 430 displays the windows of such specification so that an important part of the window having a higher display priority can readily be viewed. Specifically, display control unit 430 may control such that the designated window (for example, window A) is displayed at the center of a circle and the other windows are arranged on its periphery in descending order of the display priority in the counterclockwise direction from the position near the right of the designated window. Further, as already described, display control unit 430 may display the windows in a stacked manner on screen 25 such that the window of a higher display priority hides at least a part of the window of a lower display priority. For the windows equal in display priority, display control unit 430 may display them in accordance with their original display priorities before designation of the window.

Further, display control unit 430 may display respective one of the windows reachable from the designated window via reference relations in an area on screen 25 that is wider than an area in which respective one of the windows for which a reference relation with another window has been detected is displayed. For example, display control unit 430 may display windows A, K, L, J and the like in a wide area and display windows P, Q, R, S and the like having no reference relation with them in a smaller area.

Alternatively, in the state (as shown, e.g., in FIG. 3) where icons that can identify windows are displayed instead of the windows, display control unit 430 may control such that the windows are displayed in accordance with calculation of the display priority, as the positions based on the display positions of the icons, corresponding to their display priorities. For example, display control unit 430 may display the icons in the form of windows such that the position on the screen where each icon is displayed corresponds to the upper left corner of the window.

The display examples described above are illustrative, and the displays by display control unit 430 are not limited thereto. For example, display control unit 430 may display the window of a high display priority closer to the center of the screen than the other windows. Alternatively, it may display the window of a high display priority by applying a color so that it is distinguishable from the other windows. Further, it may display the window of a high display priority in an area wider than those for the other windows.

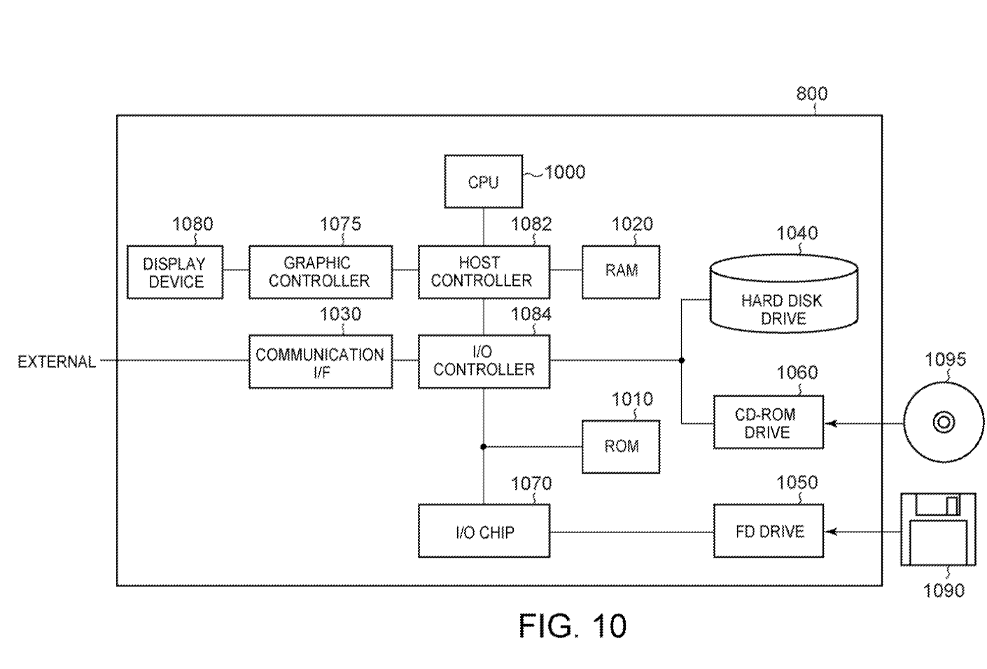

FIG. 10 shows an example of hardware configuration of an information processing apparatus 800 that serves as web server 40. Information processing apparatus 800 includes a CPU peripheral portion having a CPU 1000, a RAM 1020 and a graphic controller 1075 connected to each other via a host controller 1082, a input/output portion having a communication interface 1030 connected to hose controller 1082 via an input/output controller 1084, a hard disk drive 1040 and a CD-ROM drive 1060, and a legacy input/output portion having a ROM 1010 connected to input/output controller 1084, a flexible disk drive 1050 and an input/output chip 1070.

Host controller 1082 connects RAM 1020 with CPU 1000 and graphic controller 1075 that access RAM 1020 at high transfer rate. CPU 1000 operates based on programs stored in ROM 1010 and RAM 1020 to control the respective portions. Graphic controller 1075 obtains image data generated on a frame buffer provided in RAM 1020 by CPU 1000 or the like, and displays the same on a display device 1080. Alternatively, graphic controller 1075 may contain therein a frame buffer for storing the image data generated by CPU 1000 or the like.

Input/output controller 1084 connects host controller 1082 and relatively fast input/output devices such as communication interface 1030, hard disk drive 1040 and CD-ROM drive 1060. Communication interface 1030 communicates via a network with an external device such as user terminal 20. Hard disk drive 1040 stores the programs and data used by information processing apparatus 800. CD-ROM drive 1060 reads the program or data from a CD-ROM 1095 and provides the same to RAM 1020 or hard disk drive 1040.

Further, input/output controller 1084 is connected with ROM 1010 and relatively slow input/output devices such as flexible disk drive 1050, input/output chip 1070 and the like. ROM 1010 stores a BIOS, a boot program executed by CPU 1000 upon activation of information processing apparatus 800, a program relying on the hardware of information processing apparatus 800, and the like. Flexible disk drive 1050 reads the program or data from a flexible disk 1090 and provides the same to RAM 1020 or hard disk drive 1040 via input/output chip 1070. Input/output chip 1070 connects various input/output devices via flexible disk 1090 and, e.g., parallel port, serial port, keyboard port, mouse port and the like.

The program provided to information processing apparatus 800 is stored in a recording medium such as flexible disk 1090, CD-ROM 1095, an IC card or the like and provided by the user. The program is read out from the recording medium via input/output chip 1070 and/or input/output controller 1084, and installed into and executed by information processing apparatus 800. The operations that the program causes information processing apparatus 800 or the like to carry out are identical to the operations in web server 40 described in conjunction with FIGS. 1-9, and therefore, description thereof will not be repeated.

The program described above may be stored in an external storage medium. For the storage medium, in addition to flexible disk 1090 and CD-ROM 1095, an optical recording medium such as DVD, PD or the like, a magneto-optical recording medium such as MD or the like, a tape medium, and a semiconductor memory such as IC card or the like may be used. Further, a storage device such as a RAM or a hard disk provided at a server system connected to a dedicated communication network or the Internet may be used as the recording medium, to provide the program via the network to information processing apparatus 800.

As described above, web server 40 according to the present embodiment automatically determines a plurality of windows closely related to each other based on the reference of the contents displayed thereon. Web server 40 then preferentially displays the closely related windows as a group. As a result, it becomes readily possible to find the windows that would likely be manipulated concurrently in parallel, even if a large number of windows are being displayed, and accordingly, the convenience of the user can be improved.

Although the program for creating a web application has been described by way of example in the present embodiment, the present invention is not limited to this embodiment. For example, instead of web server 40, user terminal 20 may have each function of the present embodiment. As an example, when a plurality of web pages are displayed on a plurality of windows by a web browser, user terminal 20 may control the display of the windows based on the reference relations among the web pages. Further, when a plurality of tables are displayed by spreadsheet software, user terminal 20 may control the display of the windows based on the reference relations among the tables.

The flowchart and block diagrams in the Figures illustrate the architecture, functionality, and operation of possible implementations of systems, methods and computer program products according to various embodiments of the present invention. In this regard, each block in the flowchart to block diagrams may represent a module, segment, or portion of code, which comprises one or more executable instructions, or corresponding hardware for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used here is for the purpose of describing particular embodiments only is not intended to be limiting of the invention. As used here, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those or ordinary skill in the art without departing from the scope and spirit of the invention. The embodiment was chosen and described in order to best explain the principles of the invention and the practical application, and to enable others of ordinary skill in the art to understand the invention or various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A system for controlling display of windows in accordance with designation of a user, comprising:
a reference detecting unit for detecting a reference relation between a designated window and respective one of other windows, the reference relation being a relation where a content displayed on one window includes a reference to a content displayed on the other window;
a priority computing unit for computing and assigning to the window for which the reference relation with the designed window has been detected a higher display priority than the window for which the reference relation with the designated window has not been detected; and
a display control unit for displaying the windows on a screen in accordance with the display priorities.

2. The system according to claim 1, further comprising an input unit for receiving from a user an input to the windows displayed on the screen, wherein
the reference detecting unit, in response to reception of an input designating one of the windows by the input unit, detects the reference by scanning a content displayed on the designated window and contents displayed on the other windows.

3. The system according to claim 1, wherein
the reference detecting unit further detects the reference relation between the window for which the reference relation with the designated window has been detected and the window for which the reference relations with the designated window has not been detected, and
the priority computing unit computes and assigns to the window reachable from the designated window via the reference relation a higher display priority than the window not reachable from the designated window via the reference relation.

4. The system according to claim 3, wherein
the reference detecting unit further detects the reference relation between one window not reachable from the designated window via the reference relation and respective one of the other windows, and
the priority computing unit computes and assigns to the one window and to the window for which the reference relation with the one window has been detected a display priority next higher to the display priority of the window reachable from the designated window via the reference relation.

5. The system according to claim 4, wherein the display control unit displays respective one of the windows reachable from the designated window via the reference relation in an area on the screen that is wider than an area in which respective one of the windows for which the reference relation with the one window has been detected is displayed.

6. The system according to claim 3, wherein the priority computing unit computes and assigns to respective one of the windows reachable from the designated window via the reference relation a higher display priority on the condition that the window is a reference target of the reference than in the case that the window is a reference source of the relation.

7. The system according to claim 3, wherein the priority computing unit computes and assigns to respective one of the windows reachable form the designated window via the reference relation a display priority determined in accordance with a type of the reference for which the window serves as one of a reference source and a reference target.

8. The system according to claim 7, wherein
in the case where a first window and a second window among the windows reachable from the designated window via the reference relation display a content of a first web page and a content of a second web page, respectively.
the plurality computing unit, on the condition that the reference relation from the first window to the second window corresponds to a relation where the second web page is displayed in response to manipulation of a manipulating object displayed on the first web page by a user, computes and assigns to the first and second windows display priorities higher than in the case of the reference relation of another type.

9. The system according to claim 7, wherein
in the case where a first window and a second window among the windows reachable from the designated window via the reference relation display an operation content of a first program and an operation content of a second program, respectively,
the priority computing unit, on the condition that the reference relation from the first window to the second window corresponds to a relation where the second program is activated in response to execution of the first program, computes and assigns to the first and second windows display priorities higher than in the case of the reference relation of another type.

10. The system according to claim 8, wherein
in the case where a first window and a second window among the windows reachable from the designated window via the reference relation display a content including definition of a variable and an operation content of a program, respectively,
the priority computing unit, on the condition that the value of the variable defined in the first window is changed in accordance with the operation of the relevant program, computes and assigns to the first and second windows display priorities lower than in the case where the window is displayed in response to the manipulation of the manipulating object by the user and higher than in another case.

11. The system according to claim 10, wherein
in the case where a first window and a second window among the windows reachable from the designated window via the reference relation display a content of a first web page and a content of a second web page, respectively.
the priority computing unit, on the condition that one of the first and second web pages is referred to by a hyperlink of the other, computes and assigns to the first and second windows display priorities lower than in the case where the value of the defined variable is changed in accordance with the operation of the program and higher than in another case.

12. The system according to claim 10, wherein
in the case where a first window and a second window among the windows reachable from the designated window via the reference relation display a content including definition of a variable and an operation content of a program, respectively,
the priority computing unit, on the condition that the value of the variable is referred to by the relevant program, computes and assigns to the first and second windows display priorities lower than in the case where the value of the defined variable is changed in accordance with the operation of the program and higher than in another case.

13. The system according to claim 1, wherein the display control unit displays the windows on the screen in a stacked manner such that the window higher in the display priority hides at least a part of the window lower in the display priority.

14. The system according to claim 13, wherein
each of the windows is configured to
show a web page or a program,
display an identifier of a variable defined in the web page or the program to the left of a row and display a value of the variable to the right of the row, and
display an identifier of the web page or the program near an upper side of the window, and
the display control unit displays the designated window at the center of a circle and the other windows along a periphery of the circle, in descending order of the display priority, in a counterclockwise direction from a position near the right of the designated window.

15. The system according to claim 13, wherein in the state where icons capable of identifying windows are displayed instead of the windows, the display control unit displays the windows in accordance with computing of the display priority, at positions based on display positions of the icons, corresponding to the display priority.

16. A method for controlling display of windows in accordance with designation of a user, comprising:
detecting a reference relation between a designated window and respective one of other windows, the reference relation being a relation where a content displayed on one window includes a reference to a content displayed on the other window;
computing and assigning to the window for which the reference relation with the designated window has been detected a higher display priority than the window for which the reference relation with the designated window has not been detected; and
displaying the windows on a screen in accordance with the display priorities.

17. A computer program product causing an information processing apparatus to function as a system that controls display of windows in accordance with designation of a user comprising:
a computer usable medium having computer usable program code embodied therewith, the computer usable program code comprising:
computer usable program code configured to detect a reference relation between a designated window and respective one of other windows, the reference relation being a relation where a content displayed on one window includes a reference to a content displayed on the other window;
computer usable program code configured to compute and assign to the window for which the reference relation with the designated window has been detected a higher display priority than the window for which the reference relation with the designated window has not been detected; and
computer usable program code configured to display the windows on a screen in accordance with the display priorities.
